(19) United States
(12) Patent Application Publication
(10) Pub. No.: US 2016/0138505 A1
(43) Pub. Date: May 19, 2016

(54) METHOD FOR SIMULATING A CRANKSHAFT SIGNAL OF AN INTERNAL COMBUSTION ENGINE FROM A CAMSHAFT SIGNAL OF THE INTERNAL COMBUSTION ENGINE

(71) Applicant: ROBERT BOSCH GMBH, Stuttgart (DE)

(72) Inventor: Ulrich-Michael Nefzer, Weinstadt (DE)

(21) Appl. No.: 14/904,137

(22) PCT Filed: Jul. 4, 2014
(86) PCT No.: PCT/EP2014/064322

§ 371 Date: Jan. 11, 2016

(30) Foreign Application Priority Data
Jul. 12, 2013 (DE) 102013213705.2

(51) Int. Cl. F02D 41/14; F02D 41/22; F02D 41/00

(52) U.S. Cl. CPC F02D 41/1401; F02D 41/009; F02D 41/222; F02D 2041/1437

(57) ABSTRACT

In a method for simulating a crankshaft signal of an internal combustion engine from a camshaft signal, in a normal operating mode of the engine, for at least one rotational speed range and/or for at least one operating state of the engine all tooth times of the teeth of a crankshaft position encoder wheel are trained, and, from these, for each tooth a correction factor is calculated for the corresponding rotational speed range and/or operating state, and in an emergency operating mode of the engine, the crankshaft position is determined from the camshaft signal, and subsequently the crankshaft signal is simulated by determining an average period duration of each tooth of the crankshaft position encoder wheel from the camshaft signal, and multiplying in each case by the correction factor for this tooth.

### BACKGROUND OF THE INVENTION

1. Field of the Invention

The present invention relates to a method for simulating a crankshaft signal of an internal combustion engine from a camshaft signal of the internal combustion engine. In addition, the present invention relates to a computer program that carries out all steps of the method according to the present invention when it is executed on a computing device. Moreover, the present invention relates to a computer program product having program code that is stored on a machine-readable carrier for carrying out the method when the program is executed on a computer or control device.

2. Description of the Related Art

The position of the crankshaft of an internal combustion engine can be ascertained using a crankshaft sensor that acquires tooth edges of a crankshaft encoder wheel connected to the crankshaft. A typical crankshaft encoder wheel has, equally distributed, 59 teeth and one gap (also referred to as 60−1 teeth), which enables a determination of the crankshaft position with a resolution of 6°. Suitable software in the engine control device can enable a still higher resolution. Through corresponding interpolation methods, the simulation of this higher resolution can be still further improved.

When there is failure of the crankshaft signal, in an emergency operating mode of the internal combustion engine a changeover takes place to a redundant system for determining the crankshaft position. For this purpose, as a rule the camshaft signal is used. The resolution of the camshaft position signal is however significantly less than that of the crankshaft signal, because camshaft encoder wheels as a rule have only a few tooth edges, in order to ensure capability for quick starting. As a result, in most systems a resolution of only 180° can be achieved. In view of dynamic influences that act on the internal combustion engine through compression, combustion, and gas exchange moments, the crankshaft signal can therefore be simulated only very imprecisely from the camshaft signal. In order to prevent damage to the engine, in emergency operation the maximum torque of the internal combustion engine must therefore be greatly limited.

### BRIEF SUMMARY OF THE INVENTION

In the method according to the present invention for simulating a crankshaft signal of an internal combustion engine from a camshaft signal of the internal combustion engine, in a normal operating mode of the internal combustion engine all tooth times of the teeth of a crankshaft encoder wheel of the internal combustion engine are trained for at least one rotational speed range of the internal combustion engine and/or for at least one operating state of the internal combustion engine, and from these a correction factor is calculated for each tooth for the corresponding rotational speed range and/or for the operating state. In an emergency operating mode of the internal combustion engine, the crankshaft position is then determined from the camshaft signal, and subsequently the crankshaft signal is simulated in which an average period duration of each tooth of the crankshaft position and encoder wheel is determined from the camshaft signal and is multiplied in each case by the correction factor for this tooth. The correction factor is in particular stored in a non-volatile memory, such as an EEPROM or a flash memory of the computing device or control device of the internal combustion engine.

It is preferable that for each rotational speed range and/or operating state the correction factor F(z) for each tooth z is calculated according to Equation 1:

$$F ( z ) = \frac{( 2 n ) \cdot t ( z )}{{\sum }_{x = 0}^{2 n - 1} t ( x )} \qquad ( Equation 1 )$$

Here, n designates the sum of the number of teeth and teeth gaps of the crankshaft position encoder wheel, and t(z) designates the tooth times of teeth z of the crankshaft position encoder wheel. According to the present invention, a tooth gap is understood as the omission of, in each case, exactly one tooth in an equidistant configuration of teeth.

The simulated crankshaft signal K(z) of each tooth z is preferably calculated according to Equation 2:

$$K ( z ) = F ( z ) \cdot T ( Φ ) \cdot \frac{ϕ ( z )}{Φ} \qquad ( Equation 2 )$$

Here, Φ designates the angle of the camshaft position encoder wheel, T(Φ) designates the tooth time of the camshaft position encoder wheel at the angle Φ, and φ(z) designates the portion of the angle Φ in which crankshaft signal K(z) is simulated.

It is preferred that, in normal operation of the internal combustion engine, all tooth times of the teeth of the crankshaft position encoder wheel are trained for a plurality of rotational speed ranges of the internal combustion engine, and, from these, a correction factor is calculated for each tooth for the corresponding rotational speed range. In addition, it is preferred that, in normal operation of the internal combustion engine, for a plurality of operating states of the internal combustion engine all tooth times of the teeth of the crankshaft position encoder wheel are trained, and from these a correction factor for the corresponding operating state is calculated for each tooth. The operating states can be in particular coasting operation, idling, or firing of the internal combustion engine.

The computer program according to the present invention carries out all steps of a method according to the present invention when it is executed on a computing device or control device. In order to enable an implementation of the method according to the present invention in an existing control device without having to make constructive modifications thereto, the computer program product according to the present invention is provided with program code that is stored on a machine-readable carrier and is used to carry out the method according to the present invention when the program is executed on a computer or control device.

### BRIEF DESCRIPTION OF THE DRAWINGS

FIG. 1 schematically shows the simulation of a crankshaft signal from a camshaft signal in a method according to the existing art.

FIG. 2 schematically shows the simulation of a crankshaft signal from a camshaft signal in a method according to a specific embodiment of the present invention.

### DETAILED DESCRIPTION OF THE INVENTION

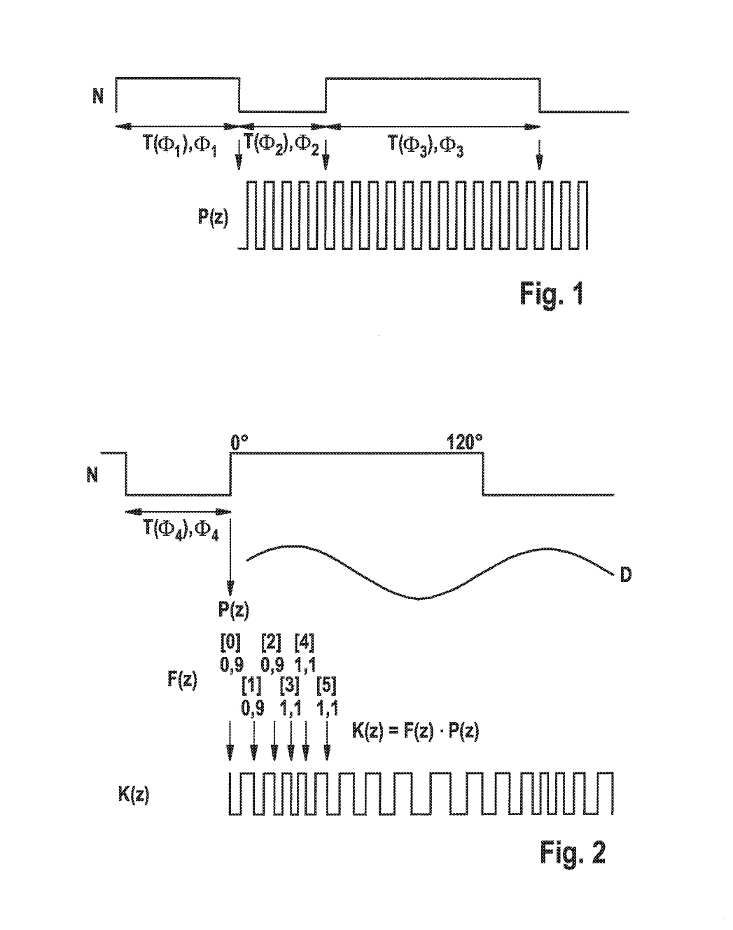

A conventional method for simulating a crankshaft signal from a camshaft signal in emergency operation of an internal combustion engine is shown in FIG. 1. Various angles Φ₁, Φ₂, Φ₃, specified by the configuration of the tooth edges of the camshaft position encoder wheel, are recognized by the camshaft sensor at tooth times T(Φ₁), T(Φ₂), T(Φ₃) that are a function of the respective angle Φ₁, Φ₂, Φ₃ and are a function of the rotational speed of the camshaft. From these, in each case a period duration P(z) of a crankshaft tooth can be simulated according to Equation 3:

$$P ( z ) = T ( Φ ) \cdot \frac{ϕ ( z )}{Φ} \qquad ( Equation 3 )$$

Here, φ(z) designates the portion of angle Φ in which the period duration P(z) can be simulated. Accordingly, in FIG. 1 φ(z)/Φ can assume five different values after camshaft tooth time T(Φ₁) and can assume twelve different values after camshaft tooth time T(Φ₂). Because the period durations P(z) can each be simulated as identical increments within a relatively long camshaft tooth time T(Φ₁), T(Φ₂), T(Φ₃), these conventional models are not capable of reproducing dynamic influences on the internal combustion engine, so that the simulated signal is imprecise.

In a specific embodiment of the method according to the present invention, in a normal operating mode of the internal combustion engine, for the rotational speed range D shown in FIG. 2, all tooth times t(z) of the teeth z of the crankshaft position encoder wheel are trained. For a conventional crankshaft position encoder wheel having 59 teeth and a gap (n=60), an average tooth time tₘᵢₜ can be calculated according to Equation 4, if the internal combustion engine is a four-cylinder engine in which one camshaft rotation corresponds to two crankshaft rotations:

$${t}_{m i t} = \frac{{\sum }_{x = 0}^{2 n - 1} t ( x )}{2 n} = \frac{{\sum }_{x = 0}^{119} t ( x )}{120} \qquad ( Equation 4 )$$

The correction factor F(z) of each tooth z can then be calculated according to Equation 5:

$$F ( z ) = \frac{t ( z )}{{t}_{m i t}} \qquad ( Equation 5 )$$

Equations 4 and 5 can also be simplified by combining them to form Equation 1.

To simulate the crankshaft signal in emergency operation of the internal combustion engine, period duration P(z) is then first calculated for each crankshaft tooth z in a conventional manner according to Equation 3. The number of crankshaft teeth z is shown in each case in square brackets in FIG. 2, and under each number the associated correction factor F(z) is shown. Each period duration P(z) is then multiplied, according to Equation 6, by the associated correction factor F(z) in order to simulate the crankshaft signal K(z):

K(z)=F(z)·P(z) (Equation 6)

In order to simplify this calculation, Equations 3 and 6 can also be combined to form Equation 2.

By applying a method according to this specific embodiment of the present invention, a more precise simulation of the crankshaft signal is possible than is possible when, in a conventional manner, only the simulated period duration of each crankshaft tooth is used as crankshaft signal. This enables, inter alia, an improvement in the exhaust gas values of the internal combustion engine during emergency operation without a crankshaft signal.

1-9. (canceled)

10. A method for simulating a crankshaft signal K(z) of an internal combustion engine from a camshaft signal of the internal combustion engine, comprising:
in a normal operating mode of the internal combustion engine, for at least one of a selected rotational speed range and a selected operating state of the internal combustion engine, all tooth times t(z) of z number of teeth of a crankshaft position encoder wheel are trained, and based on the trained tooth times, for each tooth of the z number of teeth a correction factor F(z) is calculated for at least one of the corresponding rotational speed range and the corresponding operating state; and
in an emergency operating mode of the internal combustion engine, the crankshaft position is determined from the camshaft signal, and subsequently the crankshaft signal K(z) is simulated by (i) determining an average period duration P(z) of each respective tooth of the z number of teeth of the crankshaft position encoder wheel from the camshaft signal, and (ii) multiplying the average period duration P(z) of each respective tooth by the correction factor F(z) for the respective tooth.

11. The method as recited in claim 10, wherein for the at least one of the selected rotational speed range and the selected operating state of the internal combustion engine, the correction factor F(z) is calculated for each tooth according to the following equation:
$$F ( z ) = \frac{( 2 n ) \cdot t ( z )}{{\sum }_{x = 0}^{2 n - 1} t ( x )}$$
where n designates the sum of the z number of teeth and tooth gaps of the crankshaft position encoder wheel.

12. The method as recited in claim 11, wherein the simulated crankshaft signal K(z) of each tooth of the crankshaft position encoder wheel is calculated according to the following equation:
$$K ( z ) = F ( z ) \cdot T ( Φ ) \cdot \frac{ϕ ( z )}{Φ}$$
where Φ designates an angle of the crankshaft position encoder wheel, T(Φ) designates the tooth time of the crankshaft position encoder wheel at the angle Φ, and φ(z) designates a portion of the angle Φ in which the crankshaft signal K(z) is simulated.

13. The method as recited in claim 12, wherein in the normal operating mode of the internal combustion engine, for a plurality of rotational speed ranges of the internal combustion engine, all tooth times t(z) of the z number of teeth of the crankshaft position encoder wheel are trained, and, based on the trained tooth times, for each tooth a correction factor F(z) is calculated for the corresponding rotational speed range.

14. The method as recited in claim 12, wherein in the normal operating mode of the internal combustion engine, for a plurality of operating states of the internal combustion engine, all tooth times t(z) of the z number of teeth of the crankshaft position encoder wheel are trained and, based on the trained tooth times, for each tooth a correction factor F(z) is calculated for the corresponding operating state.

15. The method as recited in claim 14, wherein one of the operating states is one of a coasting operation, idling, or a firing state.

16. The method as recited in claim 15, wherein the correction factors F(z) are stored in a non-volatile memory of one of a computing device or a control device.

17. A non-transitory, computer-readable data storage medium storing a computer program having program codes which, when executed on a computer, perform a method for simulating a crankshaft signal K(z) of an internal combustion engine from a camshaft signal of the internal combustion engine, the method comprising:
in a normal operating mode of the internal combustion engine, for at least one of a selected rotational speed range and a selected operating state of the internal combustion engine, all tooth times t(z) of z number of teeth of a crankshaft position encoder wheel are trained, and based on the trained tooth times, for each tooth of the z number of teeth a correction factor F(z) is calculated for at least one of the corresponding rotational speed range and the corresponding operating state; and
in an emergency operating mode of the internal combustion engine, the crankshaft position is determined from the camshaft signal, and subsequently the crankshaft signal K(z) is simulated by (i) determining an average period duration P(z) of each respective tooth of the z number of teeth of the crankshaft position encoder wheel from the camshaft signal, and (ii) multiplying the average period duration P(z) of each respective tooth by the correction factor F(z) for the respective tooth.
